(19) United States
(12) Patent Application Publication
(10) Pub. No.: US 2007/0297800 A1
(43) Pub. Date: Dec. 27, 2007

(54) Wavelength Division Multiplexing Passive Optical Network System

(76) Inventors: Jun-Kook Choi, Seoul (KR); So-Young Lee, Gyeongsangbuk-do (KR); Seung-Min Kang, Gyeongsangbuk-do (KR)

Correspondence Address: CANTOR COLBURN, LLP, 55 GRIFFIN ROAD SOUTH, BLOOMFIELD, CT, 06002, US

(21) Appl. No.: 11/547,917

(22) PCT Filed: Apr. 4, 2005
(86) PCT No.: PCT/KR05/00970

§ 371 Date: Aug. 3, 2007

(30) Foreign Application Priority Data
Apr. 8, 2004 (KR) 10-2004-0024234
Apr. 26, 2004 (KR) 10-2004-0028752

(51) Int. Cl. H04J 14/00

(52) U.S. Cl. 398/71; 398/70

(57) ABSTRACT

The present invention relates to a Wavelength Division Multiplexing (WDM) Passive Optical Network (PON) system and a multi-ring type WDM PON system. The WDM PON system is implemented to appropriately compensate signals that are transmitted and received between an optical communication line and the multiplexer/demultiplexer of a Central Office (CO). A plurality of ring-type optical communication lines is employed in the WDM PON system. Accordingly, various types of loss caused by various environmental factors, such as insertion loss caused by interfacing a variety of devices with an optical communication line and loss caused by the degradation of an optical cable, are compensated for, thus improving the quality and stability of communication.

### TECHNICAL FIELD

The present invention relates, in general, to a wavelength division multiplexing passive optical network system and a multi-ring type wavelength division multiplexing passive optical network system, and more particularly, to a wavelength division multiplexing passive optical network system that is capable of compensating for various types of loss, such as connection node loss, that are caused by interfacing a variety of devices with at least one optical communication line.

### BACKGROUND ART

Wavelength Division Multiplexing (WDM) is a method in which a Central Office (CO) assigns different wavelengths to individual subscribers and data are simultaneously transmitted. Each subscriber can always transmit or receive data using an assigned wavelength. This method is advantageous in that a large capacity of data can be transmitted to each subscriber, the security of communication is excellent and it is easy to improve performance.

Meanwhile, a Passive Optical Network (PON), that is, one of the methods of constructing Fiber-to-the-home (FTTH), is a method in which one Optical Line Termination (OLT) can connect a plurality of Optical Network Units (ONUs) using a passive optical distribution device on a single optical cable. In the PON, data are transmitted from the CO up to a Remote Node (RN) over a single optical fiber, divided by the passive optical distribution device of the RN, and then transmitted to individual subscribers over separate optical fibers. That is, the PON has a configuration in which a CO is connected to an RN installed at a location adjacent to subscribers via a single optical fiber and the RN is connected to individual subscribers via separate optical fibers, so that the cost of cables can be reduced compared to the case where individual optical cables are installed to run all the way from the CO to the subscribers.

One WDM PON system can be implemented by combining the above-described WDM technology and PON technology together. Such a WDM PON system generally adopts a redundant structure having redundant components so as to substitute for a cut optical fiber, a defective Laser Diode (LD; corresponding to an optical transmission unit) or a defective Photodiode (PD; corresponding to an optical reception unit).

The applicant of the present invention proposed a WDM PON system that is capable of extending the life spans of optical sources and lowering the transmission error rate of data packets by fundamentally blocking light that can be introduced into the optical sources, in Korean Pat. Appl. No. 2003-98904 (filed on Dec. 29, 2003). In Korean Pat. Appl. No. 2004-24234 (filed on Apr. 8, 2004), the applicant also proposed a WDM PON system that can appropriately compensate for various types of loss caused by various environmental factors, such as insertion loss caused by interfacing various devices with a ring-type optical communication line and loss caused by the degradation of an optical cable.

FIG. 1 is a schematic diagram of the WDM PON system that was proposed in Korean Pat. Appl. No. 2003-98904 filed by the applicant of the present invention.

As shown in the drawing, the WDM PON system includes a ring-type optical communication line 100, a CO 200 and a plurality of RNs 300. The CO 200 is connected to the plurality of RNs 300 through the ring-type optical communication line 100.

The CO 200 includes a plurality of optical transmission units 210 that generates optical signals having different wavelengths, and a plurality of optical reception units 220 each of which forms a pair with a corresponding optical transmission unit 210, receives an optical signal having the same wavelength as the corresponding optical transmission unit 210, and converts the optical signal into an electrical signal. In this case, implementation can be conducted so that the optical transmission units 210 generate an optical signal having a single wideband wavelength rather than optical signals having different wavelengths, and optical signals having different wavelengths are produced using a grating device (not shown).

The CO 200 further includes a multiplexer/demultiplexer 230 that multiplexes the optical signals of different wavelengths, which are received through optical circulators 240 that will be described later, and then outputs a multiplexed optical signal to the optical communication line 100, and demultiplexes the multiplexed optical signal that is received through the optical communication line 100 and then outputs demultiplexed optical signals to the optical circulators 240.

The CO 200 further includes a plurality of optical circulators 240, each of which outputs an optical signal, which is output from a designated one of the optical transmission units 210, to the multiplexer/demultiplexer 230, and outputs one of the optical signals, which are demultiplexed by and received from the multiplexer/demultiplexer 230, to a designated one of the optical reception units 220.

The optical circulators 240 are optical devices that are designed such that light incident through an input port is not allowed to return to the same port at all. This implies that light generated from an optical source is not introduced into the same optical source regardless of the path by which it travels. The operation of the optical circulators 240 is shown in FIG. 2. As shown in FIG. 2, an optical signal input through a port 1 is output through a port 2, and an optical signal incident through the port 2 is output through a port 3. A connection between the port 3 and the port 1 is not available. Therefore, if the port 1 of each optical circulator 240 is connected to one optical transmission unit 210, and the ports 2 and 3 of each optical circulator 240 are connected to the multiplexer/demultiplexer 230 and the optical reception unit 220, respectively, optical signals generated from the optical transmission units 210 are input to the multiplexer/demultiplexer 230 through ports 2 and then multiplexed in the multiplexer/demultiplexer 230, and a multiplexed signal is transmitted to the RNs 300 through the optical communication line 100. Additionally, the optical signal circulating through the ring-type optical communication line 100 is demultiplexed in the multiplexer/demultiplexer 230, and demultiplexed optical signals are introduced into the ports 2 of the optical circulators 240, respectively, so that the optical reception units 220 can receive the multiplexed optical signals through the ports 3, respectively. In this case, the optical signals introduced through the ports 2 do not return to the ports 1 but are output only through the port 3, so that a phenomenon in which optical signals are introduced into optical sources does not occur.

Therefore, there is an advantage in that a packet transmission error does not occur during low-rate data transmission or high-rate data transmission.

The RN 300 includes an optical add/drop multiplexer 310 that drops only signals having wavelengths in a predetermined band from the optical signals transmitted through the optical communication line 100 and outputs the dropped signals to subscriber devices (not shown), and also outputs optical signals received from the optical transmission units of the subscriber devices to the optical communication line 100, and a plurality of optical circulators 321a and 321b that outputs optical signals that are dropped through the optical add/drop multiplexer 310 to the optical reception units of the subscriber devices, and outputs optical signals that are received from the optical transmission units of the subscriber devices to the optical add/drop multiplexer 310.

FIG. 3 shows an example of a bidirectional optical add/drop multiplexer 310. The bidirectional optical add/drop multiplexer 310 has signal flows in opposite directions on the optical communication line 100 forming a ring. The bidirectional optical add/drop multiplexer 310 includes a first WDM thin film filter that outputs only a signal that belongs to the signals input from the optical communication line 100 through a Com IN port as shown in the drawing and that has a wavelength in a predetermined band, to the optical reception unit of the subscriber device, and receives a signal having the same wavelength as that of the output signal from the optical transmission unit of the subscriber device and reflects the received signal to the optical communication line 100, and a second WDM thin film filter that outputs only a signal having a wavelength in a predetermined band, which belongs to the signals received from the optical communication line 100 through a Com Out port, to another redundant optical reception unit of the subscriber device, and receives a signal having the same wavelength as that of the output signal from another redundant optical transmission unit and reflects the received signal to the optical communication line 100. With the bidirectional optical add/drop multiplexer 310, each of the RNs 300 can transmit optical signals, which are received from subscriber devices (not shown), clockwise or counterclockwise on a ring-type distribution network.

In this case, each of the RNs 300 can prevent optical signals from being introduced into the optical transmission unit of each subscriber device using the optical circulators 321a and 321b that operate in the same manner as that shown in FIG. 2.

Meanwhile, Korean Pat. Appl. No. 2003-98904 filed by the applicant of the present invention proposed a WDM PON system that adopted a general Media Converter (MC) as still another embodiment.

In the present invention, a CO 200 includes a plurality of general MCs that includes a plurality of optical transmission units 210 that generate optical signals having different wavelengths, a plurality of optical reception units 220 each of which forms a pair with a corresponding one of the optical transmission units 210, receives an optical signal having the same wavelength as the corresponding optical transmission unit 210 and converts the received optical signal into an electrical signal, a multiplexer/demultiplexer 230 that multiplexes optical signals having different wavelengths, which are received from the general MCs and then outputs the multiplexed optical signal to an optical communication line 100, and demultiplexes a multiplexed optical signal received through the optical communication line 100 and then outputs the demultiplexed optical signals to the general MCs, and a plurality of optical circulators 240 that output the optical signals output from the optical transmission units 210 of the general MCs to the multiplexer/demultiplexer 230, and outputs the optical signals, which are demultiplexed in the multiplexer/demultiplexer 230, to the optical reception units 220 of the general MCs.

Meanwhile, the RN 300, as shown in FIG. 10, includes an optical add/drop multiplexer 310 that drops only signals having wavelengths in a predetermined band, which belong to the optical signals transmitted through the optical communication line 100, and then outputs the dropped signals to subscriber devices, and also outputs optical signals received from the subscriber devices to the optical communication line 100, and a redundancy MC 320 that includes first and second optical circulators 321a and 321b respectively connected to the master and slave channels of the optical add/drop multiplexer 310, master and slave optical transceiver units 322a and 322b configured to generate optical signals and then transmit the generated optical signals to one of the first and second optical circulators 321a and 321b, and convert optical signals transmitted through the optical circulators 321a and 321b into electrical signals and then output the converted optical signals to the subscriber devices, a control unit 323 configured to detect the states of the master and slave optical transceiver units 322a and 322b and the cut state of the line and activate only one of the optical transceiver units 322a and 322b, and interface units 324a and 324b connected to the master and slave optical transceiver units 322a and 322b, respectively, and configured to perform data interfacing with the subscriber devices. Since the operation of the above-described WDM PON system is described in detail in the specification of the preceding patent application, a detailed description thereof is omitted.

The WDM PON system, which was proposed in Korean Pat. Appl. No. 2003-98904 filed by the applicant of the present invention, adopted an optical coupler 400 between the multiplexer/demultiplexer 230 of the CO 200 and the optical communication line 100, and the optical coupler 400 functions to divide a multiplexed signal output from the multiplexer/demultiplexer 230 and then transmit the divided signals to different optical communication lines 100, and transmit an optical signal output from one of the optical communication lines 100 to the multiplexer/demultiplexer 230.

Meanwhile, the WDM PON system proposed in Korean Pat. Appl. No. 2003-98904 does not compensate for loss caused by various environmental factors, such as insertion loss caused by interfacing a variety of devices with a ring-type optical communication line and loss caused by the degradation of an optical cable, so that there is concern over the occurrence of the problem of quality degradation.

### DESCRIPTION OF DRAWINGS

FIG. 1 is a schematic diagram of a WDM PON system;

FIG. 2 is a diagram showing an example of the operation of an optical circulator;

FIG. 3 is a diagram showing an example of the operation of an optical add/drop multiplexer;

FIG. 4 is a diagram showing the construction of the signal compensation unit of a WDM PON system according to a first embodiment of the present invention;

FIG. 5 is a diagram showing the construction of the signal compensation unit of a WDM PON system according to a second embodiment of the present invention;

FIG. 6 is a diagram showing the construction of the signal compensation unit of a WDM PON system according to a third embodiment of the present invention;

FIG. 7 is a diagram showing the construction of the signal compensation unit of a WDM PON system according to a fourth embodiment of the present invention;

FIG. 8 is a diagram showing the construction of the signal compensation unit of a WDM PON system according to a fifth embodiment of the present invention;

FIG. 9 is a diagram showing the construction of the signal compensation unit of a WDM PON system according to a sixth embodiment of the present invention;

FIG. 10 is a diagram showing an embodiment of a redundancy general MC; and

FIG. 11 is a schematic view of a multi-ring type WDM PON system according to the present invention.

### DISCLOSURE

### Technical Problem

Therefore, the inventor of the present invention carried out research into a WDM PON system that can appropriately compensate for loss caused by various environmental factors, such as insertion loss caused by interfacing a variety of devices with a ring-type optical communication line and loss caused by the degradation of an optical cable.

Furthermore, the inventor carried out research into a multi-ring type WDM PON system that can not only accommodate more subscribers using the same system by adopting a plurality of ring-type optical communication lines in the WDM PON system based on the prior art technology filed by the applicant of the present invention, but also appropriately compensate for loss caused by various environmental factors, such as insertion loss caused by interfacing a variety of devices with the ring-type optical communication lines and loss caused by the degradation of an optical cable.

### Technical Solution

The present invention has been made in view of the above-described technical problem, and an object of the present invention is to provide a WDM PON system that is capable of appropriately compensating for various types of loss caused by various environmental factors, such as insertion loss caused by interfacing a variety of devices with a ring-type optical communication line and loss caused by the degradation of an optical cable.

The present invention has been made in view of the above-described technical problem, and another object of the present invention is to provide a multi-ring type WDM PON system that can not only accommodate more subscribers using the same system by adopting a plurality of ring-type optical communication lines in the WDM PON system, but also appropriately compensate for loss caused by various environmental factors, such as insertion loss caused by interfacing a variety of devices with the ring-type optical communication lines and loss caused by the degradation of an optical cable.

### ADVANTAGEOUS EFFECTS

A WDM PON system and a multi-ring type WDM PON system according to the present invention has an advantage in that the quality and stability of communication can be improved by appropriately compensating for various types of loss caused by various environmental factors, such as insertion loss caused by interfacing a variety of devices with a ring-type optical communication line and loss caused by the degradation of an optical cable.

### BEST MODE

In order to accomplish the above objects, according to an aspect of the present invention, there is provided a WDM PON system, including a ring-type optical communication line; a Central Office (CO) having a plurality of optical transmission units that generates optical signals having different wavelengths, optical reception units, each of which forms a pair with a corresponding one of the optical transmission units, receives an optical signal having a wavelength identical to that of the corresponding optical transmission unit and converts the optical signal into an electrical signal, a multiplexer/demultiplexer that multiplexes input optical signals having different wavelengths and then outputs a multiplexed optical signal to the optical communication line, and demultiplexes a multiplexed optical signals that is received through the optical communication line and then outputs demultiplexed optical signals, and a plurality of optical circulators each of which outputs an optical signal, which is output from a designated one of the optical transmission units, to the multiplexer/demultiplexer, and output an optical signal, which is demultiplexed in the multiplexer/demultiplexer and then received, to a designated one of the optical reception units; and one or more RNs each comprising an optical add/drop multiplexer that drops only signals having wavelengths in a predetermined band from optical signals transmitted through the optical communication line and then outputs the dropped signals to subscriber devices, and outputs optical signals, which are received from the subscriber devices, to the optical communication line, and optical circulators that output optical signals, which are dropped through the optical add/drop multiplexer, to the optical reception units of the subscriber devices, and output optical signals, which are received from the optical transmission units of the subscriber devices, to the optical add/drop multiplexer; wherein the WDM PON system further comprises a signal compensation unit that compensates signals that are transmitted and received between the optical communication line and the multiplexer/demultiplexer of the CO.

Therefore, through a signal compensation unit, various types of loss caused by various environmental factors, such as insertion loss caused by interfacing a variety of devices with a ring-type optical communication line and loss caused by the degradation of an optical cable, can be appropriately compensated for.

In order to accomplish the above objects, according to another aspect of the present invention, there is provided a multi-ring type WDM PON system, including a ring-type optical communication line; a CO comprising a plurality of optical transmission units that generate optical signals having different wavelengths, optical reception units each of which forms a pair with a corresponding one of the optical transmission units, receives an optical signal having a wavelength identical to that of the corresponding one of the optical transmission units and converts the optical signal into an electrical signal, a multiplexer/demultiplexer that multiplexes input optical signals having different wavelengths and then outputs a multiplexed optical signal to the optical communication line, and demultiplexes and outputs multiplexed optical signals that are received through the optical communication line, and a plurality of optical circulators each of which outputs an optical signal, which is output from a designated one of the optical transmission units, to the multiplexer/demultiplexer, and outputs an optical signal, which is demultiplexed and received by the multiplexer/demultiplexer, to a designated one of the optical reception units; and one or more RNs comprising an optical add/drop multiplexer that drops only signals having wavelengths in a predetermined band from optical signals transmitted through the optical communication line and then outputs the dropped signals to subscriber devices, and outputs optical signals, which are received from the subscriber devices, to the optical communication line, and optical circulators that output optical signals, which are dropped through the optical add/drop multiplexer, to the optical reception units of the subscriber devices, and output optical signals, which are received from the optical transmission units of the subscriber devices, to the optical add/drop multiplexer; wherein the WDM PON system comprises a plurality of ring-type optical communication lines; a plurality of signal compensation units that are connected to the ring-type optical communication lines, respectively, and compensate signals transmitted and received between the optical communication line and the multiplexer/demultiplexer of the CO; and an optical coupler that is connected between each of the plurality of signal compensation units and the multiplexer/demultiplexer of the CO, and divides a signal output from the multiplexer/demultiplexer and then outputs divided signals to the respective signal compensation units, or outputs signals, which are respectively output from the signal compensation units, to the multiplexer/demultiplexer.

### MODE FOR INVENTION

With reference to the accompanying drawings, the present invention is described in detail below in conjunction with preferred embodiments so that it can be easily understood and reproduced by those skilled in the art.

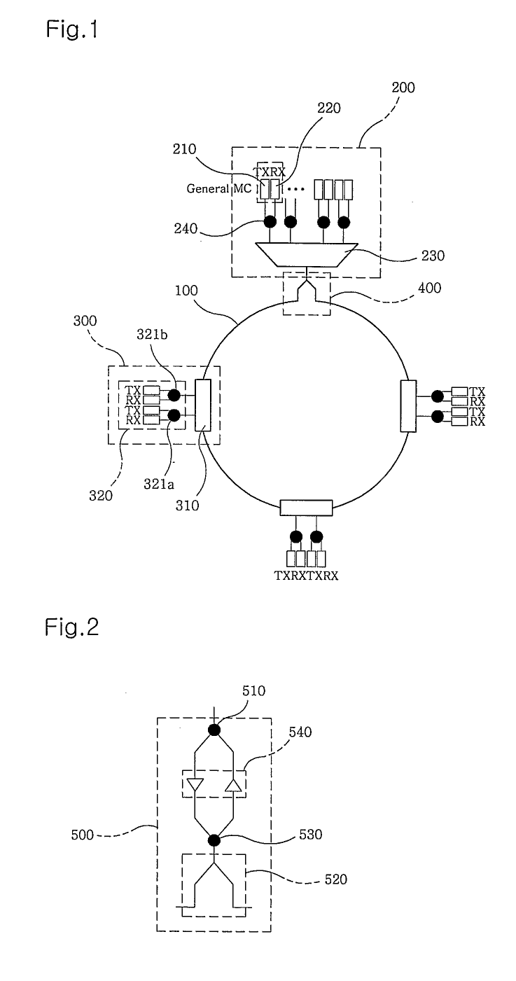

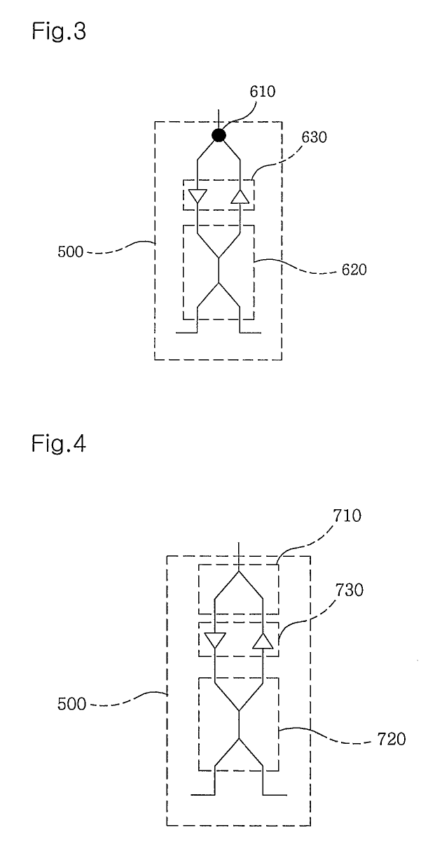

A WDM PON system according to the present invention adopts a signal compensation unit 500 instead of the optical couplers 400 connected between the multiplexer/demultiplexer 230 of the CO 200 and the optical communication line 100 of the WDM PON system shown in FIG. 1 that is proposed in Korean Pat. Appl. No. 2003-98904 filed by the applicant of the present invention, thus appropriately compensating for various types of loss caused by various environmental factors, such as insertion loss caused by interfacing a variety of devices with a ring-type optical communication line and loss caused by the degradation of an optical cable.

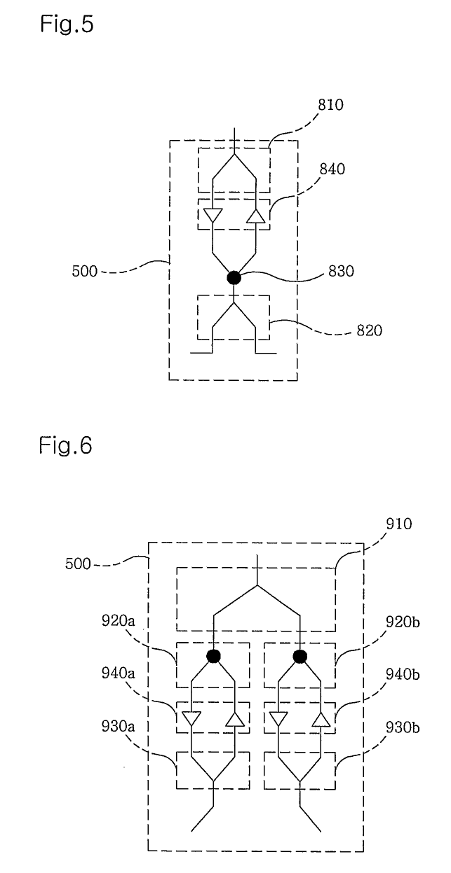

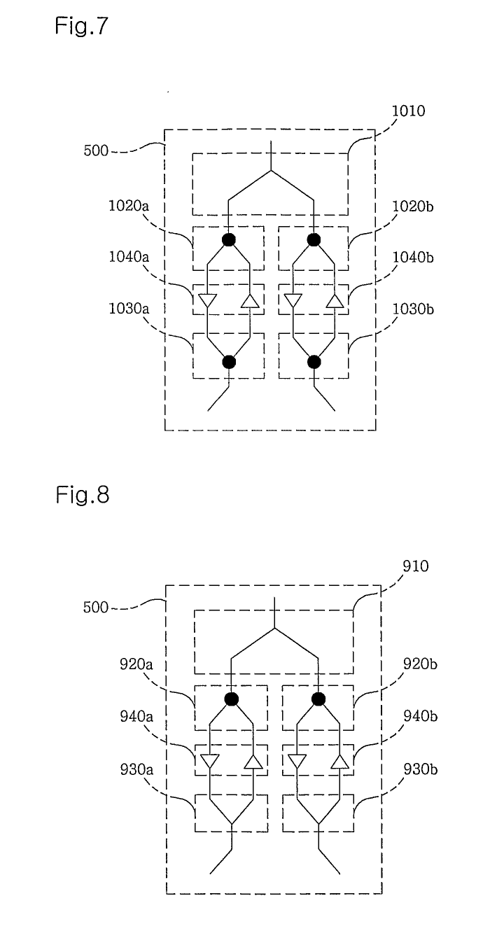

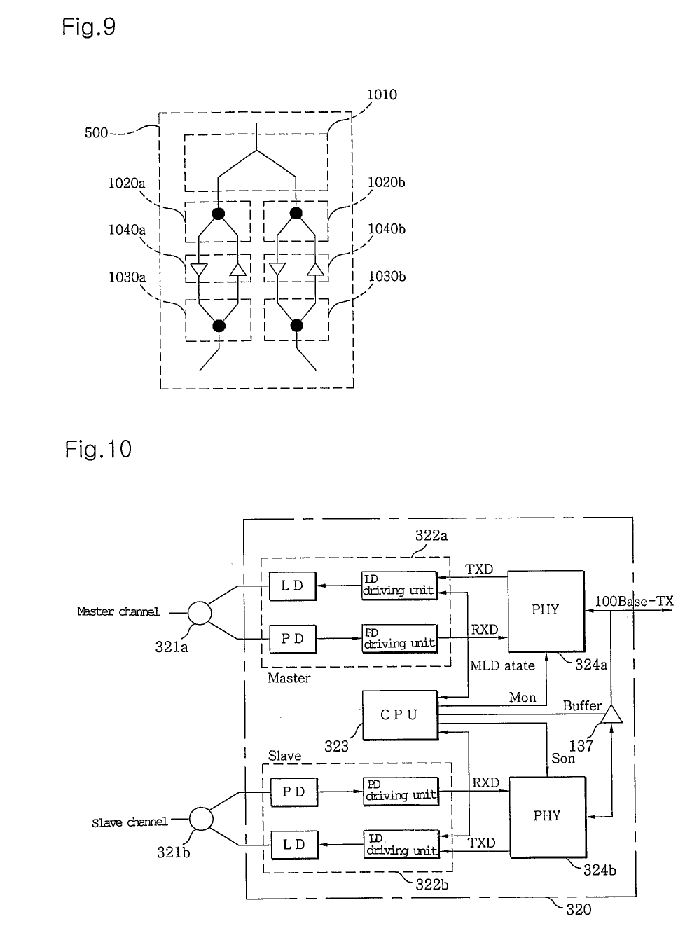

FIG. 4 is a diagram showing the construction of the signal compensation unit of a WDM PON system according to a first embodiment of the present invention. FIG. 5 is a diagram showing the construction of the signal compensation unit of a WDM PON system according to a second embodiment of the present invention. FIG. 6 is a diagram showing the construction of the signal compensation unit of a WDM PON system according to a third embodiment of the present invention. FIG. 7 is a diagram showing the construction of the signal compensation unit of a WDM PON system according to a fourth embodiment of the present invention. FIG. 8 is a diagram showing the construction of the signal compensation unit of a WDM PON system according to a fifth embodiment of the present invention. FIG. 9 is a diagram showing the construction of the signal compensation unit of a WDM PON system according to a sixth embodiment of the present invention.

In more detail, in accordance with the WDM PON system according to the first embodiment of the present invention, the signal compensation unit 500 includes a first optical circulator 510, a 1×2 coupler 520, a second optical circulator 530 and a pair of amplifiers 540.

The first optical circulator 510 allows a signal, which is output from the multiplexer/demultiplexer 230 of the CO 200, and a signal, which is input to the multiplexer/demultiplexer 230 of the CO 200, to be transmitted and received along different paths.

The 1×2 coupler 520 divides and outputs a signal to be transmitted to the optical communication line 100, and receives a signal transmitted from the optical communication line 100.

The second optical circulator 530 allows a signal, which is input from the 1×2 coupler 520, and a signal, which is output to the 1×2 coupler 520, to be transmitted and received along different paths.

The amplifiers 540 are disposed in opposite directions on two paths between the first optical circulator 510 and the second optical circulator 530, and compensate signals, which are transmitted and received along the two paths, by amplifying the signals.

That is, the first embodiment is implemented using the two optical circulators 510 and 530 to prevent reflected optical signals from being introduced into the multiplexer/demultiplexer 230 of the CO 200 and the optical communication line 100. One port of the first optical circulator 510 is connected to the multiplexer/demultiplexer 230 of the CO 200, and the remaining two ports thereof are respectively connected to first sides of the amplifiers 540 that are disposed in opposite directions.

The two ports of the second optical circulator 530 are respectively connected to the second sides of the amplifiers 540 that are disposed in opposite directions. The one remaining port of the second optical circulator 530 is connected to the first side of the 1×2 coupler 520.

The two divided second ends of the 1×2 coupler 520 are connected to the optical communication line 100.

Therefore, optical signals that are transmitted and received between the multiplexer/demultiplexer 230 of the CO 200 and the optical communication line 100 have different transmission paths through the two optical circulators 510 and 530. Signals that are transmitted and received by the pair of amplifiers 540 disposed in opposite directions along the two transmission paths are appropriately amplified, thus appropriately compensating for various types of loss caused by various environmental factors, such as insertion loss caused by interfacing a variety of devices with ring-type optical communication lines and loss caused by the degradation of an optical cable.

The second to fourth embodiments that are described below have a configuration in which the number of optical circulators is reduced and a coupler is used so as to minimize the increase of cost incurred by adopting the two optical circulators of the first embodiment. The coupler is not advantageous in terms of stability compared to the optical circulator, but is advantageous in cost versus loss compensation performance.

In accordance with the WDM PON system according to the second embodiment of the present invention, the signal compensation unit 500 includes an optical circulator 610, a 2×2 coupler 620 and a pair of amplifiers 630.

The optical circulator 610 allows a signal, which is output from the multiplexer/demultiplexer 230 of the CO 200, and a signal, which is input to the multiplexer/demultiplexer 230 of the CO 200, to be transmitted and received along different paths.

The 1×2 coupler 620 divides and outputs a signal transmitted to the optical communication line 100, and divides and outputs a signal received from the optical communication line 100.

The amplifiers 630 are disposed in opposite directions on two paths between the optical circulator 610 and the 2×2 coupler 620, and compensate signals, which are transmitted and received along the two paths, by amplifying the signals.

That is, the second embodiment is implemented using one optical circulator 610 so as to prevent reflected optical signals from being introduced into the multiplexer/demultiplexer 230 of the CO 200. One port of the optical circulator 610 is connected to the multiplexer/demultiplexer 230 of the CO 200, and the remaining two ports thereof are respectively connected to the first sides of the pair of amplifiers 630 disposed in opposite directions.

The two divided ends of one side of the 2×2 coupler 620 are connected to the second sides of the pair of amplifiers 630 disposed in opposite directions. The two divided ends of the other side of the 2×2 coupler 620 are connected to the optical communication line 100.

Therefore, optical signals that are transmitted and received between the multiplexer/demultiplexer 230 of the CO 200 and the optical communication line 100 have different transmission paths through the optical circulator 610 and the 2×2 coupler 620. Signals that are transmitted and received by the pair of amplifiers 630 disposed in opposite directions along the two transmission paths are appropriately amplified, thus appropriately compensating for various types of loss caused by various environmental factors, such as insertion loss caused by interfacing a variety of devices with ring-type optical communication lines and loss caused by the degradation of an optical cable.

In accordance with the WDM PON system according to the third embodiment of the present invention, a signal compensation unit 500 includes a 1×2 coupler 710, a 2×2 coupler 720 and a pair of amplifiers 730.

The 1×2 coupler 710 divides and outputs a signal that is output from the multiplexer/demultiplexer 230 of the CO 200, and receives a signal to be transmitted to the multiplexer/demultiplexer 230 of the CO 200.

The 2×2 coupler 720 divides and outputs a signal to be transmitted to the optical communication line 100, and divides and output a signal received from the optical communication line 100.

The amplifiers 730 are disposed in opposite directions on two paths between the 1×2 coupler 710 and the 2×2 coupler 720, and compensate signals, which are transmitted and received along the two paths, by amplifying the signals.

That is, the third embodiment is not superior in the efficiency of blocking reflected signals to the first and second embodiments because it does not adopt the optical circulator, but is implemented to minimize the cost. One side of the 1×2 coupler 710 is connected to the multiplexer/demultiplexer 230 of the CO 200. The two divided ends of the other side of the 1×2 coupler 710 are respectively connected to the first sides of the pair of amplifiers 730 disposed in opposite directions.

The two divided ends of one side of the 2×2 coupler 720 are connected to the second sides of the pair of amplifiers 730 disposed in opposite directions. The two divided ends of the other side of the 2×2 coupler 720 are connected to the optical communication line 100.

Therefore, optical signals that are transmitted and received between the multiplexer/demultiplexer 230 of the CO 200 and the optical communication line 100 have different transmission paths through the 1×2 coupler 710 and the 2×2 coupler 720. Signals that are transmitted and received by the pair of amplifiers 730 disposed in opposite directions along the two transmission paths are appropriately amplified, thus appropriately compensating for various types of loss caused by various environmental factors, such as insertion loss caused by interfacing a variety of devices with a ring-type optical communication line and loss caused by the degradation of an optical cable.

In accordance with the WDM PON system according to the fourth embodiment of the present invention, the signal compensation unit 500 includes a first 1×2 coupler 810, a second 1×2 coupler 820, an optical circulator 830 and a pair of amplifiers 840.

The first 1×2 coupler 810 divides and outputs a signal output from the multiplexer/demultiplexer 230 of the CO 200, and receives a signal to be transmitted to the multiplexer/demultiplexer 230 of the CO 200.

The second 1×2 coupler 820 divides and outputs a signal to be transmitted to the optical communication line 100, and receives a signal output from the optical communication line 100.

The optical circulator 830 allows a signal, which is received from the second 1×2 coupler 820, and a signal, which is output to the second 1×2 coupler 820, to be transmitted and received along different paths.

The amplifiers 840 are disposed in opposite directions on two paths between the first 1×2 coupler 810 and the optical circulator 830, and compensate signals, which are transmitted and received along the two paths, by amplifying the signals.

That is, the fourth embodiment is implemented using one optical circulator 830 so as to prevent reflected optical signals from being introduced into the optical communication path 100. One side of the first 1×2 coupler 810 is connected to the multiplexer/demultiplexer 230 of the CO 200. The two divided ends of the other side of the first 1×2 coupler 810 are respectively connected to the first sides of the pair of amplifiers 840 disposed in opposite directions.

The two ports of the optical circulator 830 are connected to the second sides of the pair of amplifiers 840 disposed in opposite directions. The one remaining port of the optical circulator 830 is connected to one side of the second 1×2 coupler 820.

Two divided ends of the other side of the second 1×2 coupler 820 are connected to the optical communication line 100.

Therefore, optical signals that are transmitted and received between the multiplexer/demultiplexer 230 of the CO 200 and the optical communication line 100 have different transmission paths through the first 1×2 coupler 810 and the optical circulator 830. Signals that are transmitted and received by the pair of amplifiers 840 disposed in opposite directions along the two transmission paths are appropriately amplified, thereby appropriately compensating for various types of loss caused by various environmental factors, such as insertion loss caused by interfacing a variety of devices with a ring-type optical communication line and loss caused by the degradation of an optical cable.

In accordance with the WDM PON system according to the fifth embodiment of the present invention, the signal compensation unit 500 includes a first 1×2 coupler 910, a pair of optical circulators 920a and 920b, a pair of second 1×2 couplers 930a and 930b, and a pair of amplifier pairs 940a and 940b.

The first 1×2 coupler 910 divides and outputs a signal output from the multiplexer/demultiplexer 230 of the CO 200, and receives a signal to be transmitted to the multiplexer/demultiplexer 230 of the CO 200.

The optical circulators 920a and 920b are respectively connected to the two ends of the divided side of the first 1×2 coupler 910, so that they allow a signal, which is divided and output by the first 1×2 coupler 910, and a signal, which will be input to the first 1×2 coupler 910, to be transmitted and received along different paths.

The pair of second 1×2 couplers 930a and 930b outputs signals to be transmitted to the optical communication line 100, and divides and outputs signals that are received from the optical communication line 100.

Each of the amplifier pairs 940a and 940b includes a pair of amplifiers that are disposed in opposite directions on two paths between each of the optical circulators 920a and 920b and each of the second 1×2 couplers 930a and 930b, and they compensate signals, which are transmitted and received along the two paths, by amplifying the signals.

That is, the fifth embodiment is implemented using the pair of optical circulators 920a and 920b so as to block reflected optical signals, which are respectively introduced through two divided paths from the optical communication path 100. One side of the first 1×2 coupler 910 is connected to the multiplexer/demultiplexer 230 of the CO 200, and the two divided ends thereof are connected to the first ports of the pair of optical circulators 920a and 920b, respectively.

The second ports of each of the optical circulators 920a and 920b are respectively connected to the first sides of each of the amplifier pairs 940a and 940b each having a pair of amplifiers disposed in opposite directions.

The first sides of each of the second 1×2 couplers 930a and 930b are connected to the second sides of each of the amplifier pairs 940a and 940b each having a pair of amplifiers disposed in opposite directions. The second sides of the second 1×2 couplers 930a and 930b are connected to the optical communication line 100.

Therefore, optical signals that are transmitted and received between the multiplexer/demultiplexer 230 of the CO 200 and the optical communication line 100 are transmitted and received along two paths divided by the first 1×2 coupler 910. Each of the two paths has different sub transmission paths through the pair of optical circulators 920a and 920b and the pair of second 1×2 couplers 930a and 930b. Signals that are transmitted and received by the amplifier pairs 940a and 940b each having a pair of amplifiers disposed on the two transmission paths in opposite directions are appropriately amplified, thus appropriately compensating for various types of loss caused by various environmental factors, such as insertion loss caused by interfacing a variety of devices with ring-type optical communication lines and loss caused by the degradation of an optical cable.

In accordance with the WDM PON system according to the sixth embodiment of the present invention, the signal compensation unit 500 includes a 1×2 coupler 1010, a pair of first optical circulators 1020a and 1020b, a pair of second optical circulators 1030a and 1030b, and a pair of amplifier pairs 1040a and 1040b.

The 1×2 coupler 1010 divides and outputs a signal output from the multiplexer/demultiplexer 230 of the CO 200, and receives a signal to be transmitted to the multiplexer/demultiplexer 230 of the CO 200.

The first optical circulators 1020a and 1020b are disposed on the divided ends of the 1×2 coupler 1010, respectively, so that they allow a signal, which is divided and output by the 1×2 coupler 1010, and a signal, which will be input to the 1×2 coupler 1010, to be transmitted and received along different paths.

The pair of second optical circulators 1030a and 1030b allows a signal, which is transmitted to the optical communication line 100, and a signal, which is received from the optical communication line 100, to be transmitted and received along different paths.

Each of the amplifier pairs 1040a and 1040b includes a pair of amplifiers that are disposed in opposite directions on two paths between each of the first optical circulators 1020a and 1020b and each of the second optical circulators 1030a and 1030b, and compensate signals, which are transmitted and received along the two paths, by amplifying the signals.

That is, the sixth embodiment is implemented using the two pairs of optical circulators 1020a and 1020b and 1030a and 1030b so as to block reflected optical signals that are introduced through two divided paths from the optical communication path 100. One side of the 1×2 coupler 1010 is connected to the multiplexer/demultiplexer 230 of the CO 200, and the two divided ends of the other side thereof are connected to the first ports of the first optical circulators 1020a and 1020b.

The second ports of each of the first optical circulators 1020a and 1020b are connected to the first sides of each of the amplifier pairs 1040a and 1040b each having a pair of amplifiers disposed in opposite directions.

The first ports of each of the second optical circulators 1030a and 1030b are connected to the second sides of each of the amplifier pairs 1040a and 1040b each having a pair of amplifiers disposed in opposite directions. The second ports of the second optical circulators 1030a and 1030b are connected to the optical communication line 100.

Therefore, optical signals that are transmitted and received between the multiplexer/demultiplexer 230 of the CO 200 and the optical communication line 100 are transmitted and received along two paths divided by the 1×2 coupler 1010. Each of the two paths has different sub transmission paths through the pair of first optical circulators 1020a and 1020b and the pair of second optical circulators 1030a and 1030b. Signals that are transmitted and received through each of the amplifier pairs 1040a and 1040b each having a pair of amplifiers disposed on two transmission paths in opposite directions are appropriately amplified, thereby appropriately compensating for various types of loss caused by various environmental factors, such as insertion loss caused by interfacing a variety of devices with a ring-type optical communication line and loss caused by the degradation of an optical cable.

Meanwhile, although detailed descriptions of other components sufficiently described in Korean Pat. Appl. Nos. 2003-98904 and 2004-24234 filed by the applicant of the present invention are omitted in the specification and drawings of the present application, the remaining components other than the signal compensation unit 500, that is, the core component of the present invention, are the same as those described in Korean Pat. Appl. Nos. 2003-98904 and 2004-24234.

Therefore, by doing so, the object of the WDM PON system according to the present invention can be accomplished.

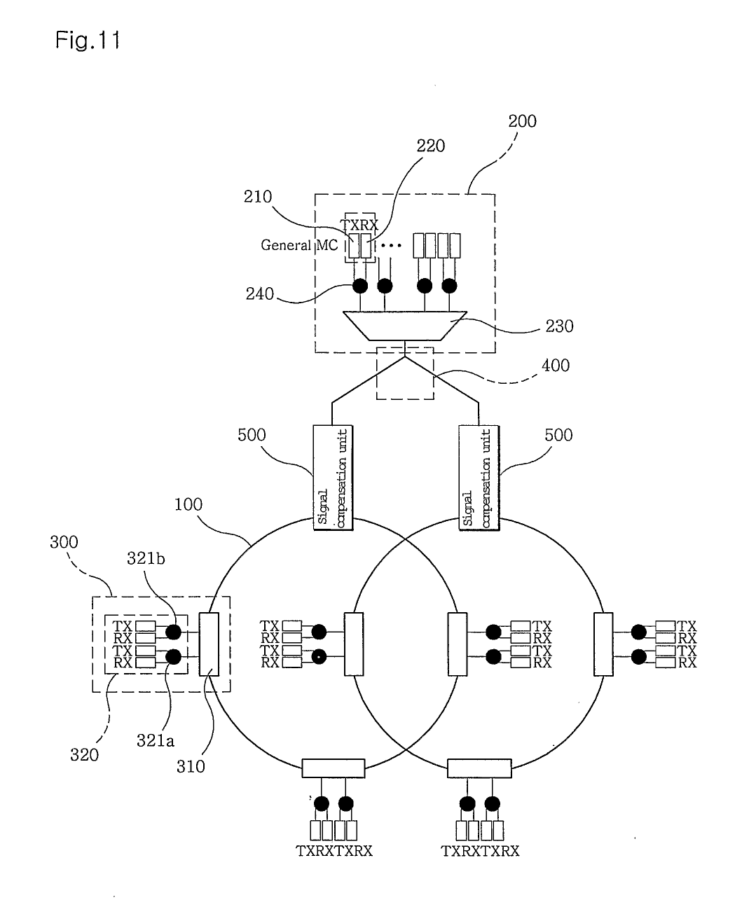

FIG. 11 is a schematic view of a multi-ring type WDM PON system according to the present invention.

As shown in the drawing, the multi-ring type WDM PON system according to the present invention includes a plurality of ring-type optical communication lines 100a and 100b, a CO 200, a plurality of RNs 300, an optical coupler 400, and a plurality of signal compensation units 500. The CO 200 is connected to the plurality of RNs 300 through the ring-type optical communication line 100a and 100b.

The CO 200 includes a plurality of optical transmission units 210 each of which generates optical signals having different wavelengths, and a plurality of optical reception units 220 each of which forms a pair with each of the optical transmission units 210, receives an optical signal having the same wavelength as that of a corresponding optical transmission unit 210 and converts the received optical signal into an electrical signal. In this case, the optical transmission units 210 may not generate optical signals having different wavelengths but can generate an optical signal having a single wideband wavelength, and a grating device (not shown) can be implemented to generate optical signals having different wavelengths.

The CO 200 further includes a multiplexer/demultiplexer 230 that multiplexes optical signals having different wavelengths received through optical circulators 240 and outputs a multiplexed optical signal to the optical communication line 100a and 100b, and demultiplexes a multiplexed optical signal received through the optical communication line 100a and 100b and outputs demultiplexed optical signals to the optical circulators 240.

Furthermore, the CO 200 includes a plurality of optical circulators 240 each of which outputs an optical signal, which is outputs from a designated one of the optical transmission units 210, to the multiplexer/demultiplexer 230, and outputs an optical signal, which is demultiplexed in the multiplexer/demultiplexer 230, to a designated one of the optical reception units 220.

The optical circulators 240 are optical devices that are designed such that light incident through an input port is not allowed to return to the same port at all. This implies that light generated from an optical source is not introduced into the same optical source regardless of the path by which it travels. Since the operation of these optical circulators 240 is described in detail in the specifications of the preceding applications of the present applicant, detailed descriptions thereof are omitted.

For example, if the port 1 of each of the optical circulators 240 is connected to each of the optical transmission units 210 and the ports 2 and 3 thereof are connected to the multiplexer/demultiplexer 230 and each of the optical reception units 220, respectively, optical signals generated from the optical transmission units 210 are multiplexed in the multiplexer/demultiplexer 230 through ports 2, and are then transmitted to the RNs 300 through the optical communication line 100a and 100b. The optical signal that is circulated through the ring-type optical communication line 100a and 100b is demultiplexed in the multiplexer/demultiplexer 230, and is then introduced into the ports 2 of the optical circulators 240. Each of the optical reception units 220 can thus receive an optical signal through the port 3. In this case, the optical signal introduced through the port 2 does not return to the port 1, but is output only through the port 3. Thus, a phenomenon in which an optical signal is introduced into an optical source does not occur.

Therefore, the present invention is advantageous in that packet transmission error does not occur during low-speed data transmission or high-speed data transmission.

Each of the RNs 300 includes an optical add/drop multiplexer 310 that drops only signals having wavelengths in a predetermined band from optical signals transmitted through the optical communication line 100a and 100b and outputs the dropped signals to subscriber devices (not shown), and also outputs optical signals received from the subscriber devices to the optical communication line 100a and 100b, and a plurality of optical circulators 321a and 321b that output the optical signals that are dropped through the optical add/drop multiplexer 310 to the optical reception units of the subscriber devices and output optical signals that are received from the optical transmission units of the subscriber devices to the optical add/drop multiplexer 310.

In this case, each RN 300 is configured so that the optical circulators 321a and 321b can prevent optical signals from being introduced into the optical transmission units of the subscriber devices.

In the drawing, reference numeral 320 designates a general MC. The operation of the general MC 320 is described in detail in the specifications of the prior applications of the present applicant. Thus, a detailed description thereof is omitted.

The optical coupler 400 is connected between the plurality of signal compensation units 500 and the multiplexer/demultiplexer 230 of the CO 200, and it divides a signal output from the multiplexer/demultiplexer 230 and then outputs divided signals to the respective signal compensation units 500, or outputs optical signals, which are output from the respective signal compensation units 500, to the multiplexer/demultiplexer 230.

The signal compensation units 500 are connected to the ring-type optical communication lines 100a and 100b, respectively, and compensate signals that are transmitted and received between the optical communication lines 100a and 100b and the multiplexer/demultiplexer 230 of the CO 200.

In other words, in accordance with the present invention, the plurality of ring-type optical communication lines 100a and 100b are used in the WDM PON system, so that the WDM PON system of the present invention can accommodate a great number of subscribers using the same system, compared to the prior art. Furthermore, the plurality of signal compensation units 500 is connected between the plurality of optical communication lines 100a and 100b and the multiplexer/demultiplexer 230 of the CO 200 through the optical coupler 400, thus appropriately compensating for various types of loss caused by various environmental factors, such as insertion loss caused by interfacing a variety of devices with the plurality of optical communication lines 100a and 100b and loss caused by the degradation of an optical cable.

Meanwhile, FIGS. 4 to 9 can also be applied to the signal compensation unit of a multi-ring type WDM PON system according to the present invention, which is shown in FIG. 11. That is, FIG. 4 is a diagram showing the construction of the signal compensation unit of a multi-ring type WDM PON system according to the first embodiment of the present invention. FIG. 5 is a diagram showing the construction of the signal compensation unit of a multi-ring type WDM PON system according to the second embodiment of the present invention. FIG. 6 is a diagram showing the construction of the signal compensation unit of a multi-ring type WDM PON system according to the third embodiment of the present invention. FIG. 7 is a diagram showing the construction of the signal compensation unit of a multi-ring type WDM PON system according to the fourth embodiment of the present invention. FIG. 8 is a diagram showing the construction of the signal compensation unit of a multi-ring type WDM PON system according to the fifth embodiment of the present invention. FIG. 9 is a diagram showing the construction of the signal compensation unit of a multi-ring type WDM PON system according to the sixth embodiment of the present invention.

These are described below again.

In accordance with the multi-ring type WDM PON system according to the first embodiment of the present invention, the signal compensation unit 500 includes a first optical circulator 510, a 1×2 coupler 520, a second optical circulator 530 and a pair of amplifiers 540.

The first optical circulator 510 allows a signal, which is output from the multiplexer/demultiplexer 230 of the CO 200 via the optical coupler 400, and a signal, which is input to the multiplexer/demultiplexer 230 of the CO 200 via the optical coupler 400, to be transmitted and received along different paths.

The 1×2 coupler 520 divides and outputs a signal to be transmitted to the optical communication line 100a or 100b, and receives a signal transmitted from the optical communication line 100a or 100b.

The second optical circulator 530 allows a signal, which is input from the 1×2 coupler 520, and a signal, which is output to the 1×2 coupler 520, to be transmitted and received along different paths.

The amplifiers 540 are disposed in opposite directions on two paths between the first optical circulator 510 and the second optical circulator 530, and compensate signals, which are transmitted and received along the two paths, by amplifying the signals.

That is, the first embodiment is implemented using the two optical circulators 510 and 530 to prevent reflected optical signals from being introduced into the multiplexer/demultiplexer 230 of the CO 200 and the optical communication line 100a and 100b. One port of the first optical circulator 510 is connected to the other end of the optical coupler 400 connected to the multiplexer/demultiplexer 230 of the CO 200, and the remaining two ports thereof are respectively connected to first sides of the amplifiers 540 that are disposed in opposite directions.

The two ports of the second optical circulator 530 are respectively connected to the second sides of the amplifiers 540 that are disposed in opposite directions. The one remaining port of the second optical circulator 530 is connected to the first side of the 1×2 coupler 520.

The two divided second ends of the 1×2 coupler 520 are connected to the optical communication line 100a and 100b.

Therefore, optical signals that are transmitted and received between the multiplexer/demultiplexer 230 of the CO 200 and the optical communication line 100a or 100b have different transmission paths through the two optical circulators 510 and 530. Signals that are transmitted and received by the pair of amplifiers 540 disposed in opposite directions along the two transmission paths are appropriately amplified, thus appropriately compensating for various types of loss caused by various environmental factors, such as insertion loss caused by interfacing a variety of devices with ring-type optical communication lines and loss caused by the degradation of an optical cable.

The second to fourth embodiments that are described below have a configuration in which the number of optical circulators is reduced and a coupler is used so as to minimize the increase of cost incurred by adopting the two optical circulators of the first embodiment. The coupler is not advantageous in terms of stability compared to the optical circulator, but is advantageous in cost versus loss compensation performance.

In accordance with the multi-ring type WDM PON system according to the second embodiment of the present invention, the signal compensation unit 500 includes an optical circulator 610, a 2×2 coupler 620 and a pair of amplifiers 630.

The optical circulator 610 allows a signal, which is output from the multiplexer/demultiplexer 230 of the CO 200 via the optical coupler 400, and a signal, which is input to the multiplexer/demultiplexer 230 of the CO 200 via the optical coupler 400, to be transmitted and received along different paths.

The 1×2 coupler 620 divides and outputs a signal transmitted to the optical communication line 100a or 100b, and divides and outputs a signal received from the optical communication line 100a or 100b.

The amplifiers 630 are disposed in opposite directions on two paths between the optical circulator 610 and the 2×2 coupler 620, and compensate signals, which are transmitted and received along the two paths, by amplifying the signals.

That is, the second embodiment is implemented using one optical circulator 610 so as to prevent reflected optical signals from being introduced into the multiplexer/demultiplexer 230 of the CO 200. One port of the optical circulator 610 is connected to the other end of the optical coupler 400 connected to the multiplexer/demultiplexer 230 of the CO 200, and the remaining two ports thereof are respectively connected to the first sides of the amplifiers 630 disposed in opposite directions.

The two divided ends of one side of the 2×2 coupler 620 are connected to the second sides of the amplifiers 630 disposed in opposite directions. The two divided ends of the other side of the 2×2 coupler 620 are connected to the optical communication line 100a or 100b.

Therefore, optical signals that are transmitted and received between the multiplexer/demultiplexer 230 of the CO 200 and the optical communication line 100a or 100b have different transmission paths through the optical circulator 610 and the 2×2 coupler 620. Signals that are transmitted and received by the pair of amplifiers 630 disposed in opposite directions along the two transmission paths are appropriately amplified, thus appropriately compensating for various types of loss caused by various environmental factors, such as insertion loss caused by interfacing a variety of devices with ring-type optical communication lines and loss caused by the degradation of an optical cable.

In accordance with the multi-ring type WDM PON system according to the third embodiment of the present invention, a signal compensation unit 500 includes a 1×2 coupler 710, a 2×2 coupler 720 and a pair of amplifiers 730.

The 1×2 coupler 710 divides and outputs a signal that is output from the multiplexer/demultiplexer 230 of the CO 200 via the optical coupler 400, and receives a signal to be transmitted to the multiplexer/demultiplexer 230 of the CO 200 via the optical coupler 400.

The 2×2 coupler 720 divides and outputs a signal to be transmitted to the optical communication line 100a or 100b, and divides and output a signal received from the optical communication line 100a or 100b.

The amplifiers 730 are disposed in opposite directions on two paths between the 1×2 coupler 710 and the 2×2 coupler 720, and compensate signals, which are transmitted and received along the two paths, by amplifying the signals.

That is, the third embodiment is not superior in the efficiency of blocking reflected signals to the first and second embodiments because it does not adopt the optical circulator, but is implemented to minimize the cost. One side of the 1×2 coupler 710 is connected to the other end of the optical coupler 400 connected to the multiplexer/demultiplexer 230 of the CO 200. The two divided ends of the other side of the 1×2 coupler 710 are respectively connected to the first sides of the pair of amplifiers 730 disposed in opposite directions.

The two divided ends of one side of the 2×2 coupler 720 are connected to the second sides of the amplifiers 730 disposed in opposite directions. The two divided ends of the other side of the 2×2 coupler 720 are connected to the optical communication line 100a or 100b.

Therefore, optical signals that are transmitted and received between the multiplexer/demultiplexer 230 of the CO 200 and the optical communication line 100a or 100b have different transmission paths through the 1×2 coupler 710 and the 2×2 coupler 720. Signals that are transmitted and received by the pair of amplifiers 730 disposed in opposite directions along the two transmission paths are appropriately amplified, thus appropriately compensating for various types of loss caused by various environmental factors, such as insertion loss caused by interfacing a variety of devices with a ring-type optical communication line and loss caused by the degradation of an optical cable.

In accordance with the multi-ring type WDM PON system according to the fourth embodiment of the present invention, the signal compensation unit 500 includes a first 1×2 coupler 810, a second 1×2 coupler 820, an optical circulator 830 and a pair of amplifiers 840.

The first 1×2 coupler 810 divides and outputs a signal output from the multiplexer/demultiplexer 230 of the CO 200 via the optical coupler 400, and receives a signal to be transmitted to the multiplexer/demultiplexer 230 of the CO 200 via the optical coupler 400.

The second 1×2 coupler 820 divides and outputs a signal to be transmitted to the optical communication line 100a or 100b, and receives a signal output from the optical communication line 100a or 100b.

The optical circulator 830 allows a signal, which is received from the second 1×2 coupler 820, and a signal, which is output to the second 1×2 coupler 820, to be transmitted and received along different paths.

The amplifiers 840 are disposed in opposite directions on two paths between the first 1×2 coupler 810 and the optical circulator 830, and compensate signals, which are transmitted and received along the two paths, by amplifying the signals.

That is, the fourth embodiment is implemented using one optical circulator 830 so as to prevent reflected optical signals from being introduced into the optical communication path 100a or 100b. One side of the first 1×2 coupler 810 is connected to the other end of the optical coupler 400 connected to the multiplexer/demultiplexer 230 of the CO 200. The two divided ends of the other side of the first 1×2 coupler 810 are respectively connected to the first sides of the amplifiers 840 disposed in opposite directions.

The two ports of the optical circulator 830 are connected to the second sides of the pair of amplifiers 840 disposed in opposite directions. The one remaining port of the optical circulator 830 is connected to one side of the second 1×2 coupler 820.

Two divided ends of the other side of the second 1×2 coupler 820 are connected to the optical communication line 100a or 100b.

Therefore, optical signals that are transmitted and received between the multiplexer/demultiplexer 230 of the CO 200 and the optical communication line 100a or 100b have different transmission paths through the first 1×2 coupler 810 and the optical circulator 830. Signals that are transmitted and received by the pair of amplifiers 840 disposed in opposite directions along the two transmission paths are appropriately amplified, thereby appropriately compensating for various types of loss caused by various environmental factors, such as insertion loss caused by interfacing a variety of devices with a ring-type optical communication line and loss caused by the degradation of an optical cable.

In accordance with the multi-ring type WDM PON system according to the fifth embodiment of the present invention, the signal compensation unit 500 includes a first 1×2 coupler 910, a pair of optical circulators 920a and 920b, a pair of second 1×2 couplers 930a and 930b, and a pair of amplifier pairs 940a and 940b.

The first 1×2 coupler 910 divides and outputs a signal output from the multiplexer/demultiplexer 230 of the CO 200 via the optical coupler 400, and receives a signal to be transmitted to the multiplexer/demultiplexer 230 of the CO 200 via the optical coupler 400.

The optical circulators 920a and 920b are respectively connected to the two ends of the divided side of the first 1×2 coupler 910, so that they allow a signal, which is divided and output by the first 1×2 coupler 910, and a signal, which will be input to the first 1×2 coupler 910, to be transmitted and received along different paths.

The pair of second 1×2 couplers 930a and 930b outputs signals to be transmitted to the optical communication line 100a or 100b, and divides and outputs signals that are received from the optical communication line 10a or 100b.

Each of the amplifier pairs 940a and 940b includes a pair of amplifiers that are disposed in opposite directions on two paths between each of the optical circulators 920a and 920b and each of the second 1×2 couplers 930a and 930b, and they compensate signals, which are transmitted and received along the two paths, by amplifying the signals.

In other words, the fifth embodiment is implemented using the pair of optical circulators 920a and 920b so as to block reflected optical signals, which are respectively introduced through two divided paths from the optical communication path 100a or 100b. One side of the first 1×2 coupler 910 is connected to the other side of the optical coupler 400 connected to the multiplexer/demultiplexer 230 of the CO 200, and the two divided ends thereof are connected to the first ports of the pair of optical circulators 920a and 920b, respectively.

The second ports of each of the optical circulators 920a and 920b are respectively connected to the first sides of each of the amplifier pairs 940a and 940b each having a pair of amplifiers disposed in opposite directions.

The first sides of each of the second 1×2 couplers 930a and 930b are connected to the second sides of each of the amplifier pairs 940a and 940b each having a pair of amplifiers disposed in opposite directions. The second sides of each of the second 1×2 couplers 930a and 930b are connected to the optical communication line 100a or 100b.

Therefore, optical signals that are transmitted and received between the multiplexer/demultiplexer 230 of the CO 200 and the optical communication line 100a or 100b are transmitted and received along two paths divided by the first 1×2 coupler 910. Each of the two paths has different sub transmission paths through the pair of optical circulators 920a and 920b and the pair of second 1×2 couplers 930a and 930b. Signals that are transmitted and received by the amplifier pairs 940a and 940b each having a pair of amplifier disposed on the two transmission paths in opposite directions are appropriately amplified, thus appropriately compensating for various types of loss caused by various environmental factors, such as insertion loss caused by interfacing a variety of devices with ring-type optical communication lines and loss caused by the degradation of an optical cable.

In accordance with the multi-ring type WDM PON system according to the sixth embodiment of the present invention, the signal compensation unit 500 includes a 1×2 coupler 1010, a pair of first optical circulators 1020a and 1020b, a pair of second optical circulators 1030a- and 1030b, and a pair of amplifier pairs 1040a and 1040b.

The 1×2 coupler 1010 divides and outputs a signal output from the multiplexer/demultiplexer 230 of the CO 200 via the optical coupler 400, and receives a signal to be transmitted to the multiplexer/demultiplexer 230 of the CO 200 via the optical coupler 400.

The first optical circulators 1020a and 1020b are disposed on the divided ends of the 1×2 coupler 1010, respectively, so that they allow a signal, which is divided and output by the 1×2 coupler 1010, and a signal, which will be input to the 1×2 coupler 1010, to be transmitted and received along different paths.

The pair of second optical circulators 1030a and 1030b allows a signal, which is transmitted to the optical communication line 100a or 100b, and a signal, which is received from the optical communication line 100a or 100b, to be transmitted and received along different paths.

Each of the amplifier pairs 1040a and 1040b includes a pair of amplifiers that are disposed in opposite directions on two paths between each of the first optical circulators 1020a and 1020b and each of the second optical circulators 1030a and 1030b, and compensate signals, which are transmitted and received along the two paths, by amplifying the signals.

That is, the sixth embodiment is implemented using the two pairs of optical circulators 1020a and 1020b and 1030a and 1030b so as to block reflected optical signals that are introduced through two divided paths from the optical communication path 100a or 100b. One side of the 1×2 coupler 1010 is connected to the other side of the optical coupler 400 connected to the multiplexer/demultiplexer 230 of the CO 200, and the two divided ends of the other side thereof are connected to the first ports of the first optical circulators 1020a and 1020b.

The second ports of each of the first optical circulators 1020a and 1020b are connected to the first sides of each of the amplifier pairs 1040a and 1040b each having a pair of amplifiers disposed in opposite directions.

The first ports of each of the second optical circulators 1030a and 1030b are connected to the second sides of each of the amplifier pairs 1040a and 1040b each having a pair of amplifiers disposed in opposite directions. The ports of the others side of the second optical circulators 1030a and 1030b are connected to the optical communication line 100a or 100b.

Therefore, optical signals that are transmitted and received between the multiplexer/demultiplexer 230 of the CO 200 and the optical communication line 100a or 100b are transmitted and received along two paths divided by the 1×2 coupler 1010. Each of the two paths has different sub transmission paths through the pair of first optical circulators 1020a and 1020b and the pair of second optical circulators 1030a and 1030b. Signals that are transmitted and received through each of the amplifier pairs 1040a and 1040b each having a pair of amplifiers disposed on two transmission paths in opposite directions are appropriately amplified, thereby appropriately compensating for various types of loss caused by various environmental factors, such as insertion loss caused by interfacing a variety of devices with a ring-type optical communication line and loss caused by the degradation of an optical cable.

Therefore, by doing so, the object of the multi-ring type WDM PON system according to the present invention can be accomplished.

Although the present invention has been described with reference to the accompanying drawings with emphasis on the preferred embodiments, it is apparent that those skilled in the art can make modifications based on the above description without departing from the scope of the present invention defined by the below-described claims.

1. A Wavelength Division Multiplexing (WDM) Passive Optical Network (PON) system, comprising:
a ring-type optical communication line;
a Central Office (CO) having a plurality of optical transmission units that generates optical signals having different wavelengths, optical reception units, each of which forms a pair with a corresponding one of the optical transmission units, receives an optical signal having a wavelength identical to that of the corresponding optical transmission unit and converts the optical signal into an electrical signal, a multiplexer/demultiplexer that multiplexes input optical signals having different wavelengths and then outputs a multiplexed optical signal to the optical communication line, and demultiplexes a multiplexed optical signals that is received through the optical communication line and then outputs demultiplexed optical signals, and a plurality of optical circulators each of which outputs an optical signal, which is output from a designated one of the optical transmission units, to the multiplexer/demultiplexer, and output an optical signal, which is demultiplexed in the multiplexer/demultiplexer and then received, to a designated one of the optical reception units; and
one or more RNs each comprising an optical add/drop multiplexer that drops only signals having wavelengths in a predetermined band from optical signals transmitted through the optical communication line and then outputs the dropped signals to subscriber devices, and outputs optical signals, which are received from the subscriber devices, to the optical communication line, and optical circulators that output optical signals, which are dropped through the optical add/drop multiplexer, to the optical reception units of the subscriber devices, and output optical signals, which are received from the optical transmission units of the subscriber devices, to the optical add/drop multiplexer;
wherein the WDM PON system further comprises a signal compensation unit that compensates signals that are transmitted and received between the optical communication line and the multiplexer/demultiplexer of the CO.

2. The WDM PON system according to claim 1, wherein the signal compensation unit comprises:
a first optical circulator that allows a signal, which is output from the multiplexer/demultiplexer of the CO, and a signal, which is input to the multiplexer/demultiplexer of the CO, to be transmitted and received along different paths;
a 1×2 coupler that divides and outputs a signal to be transmitted to the optical communication line and receives a signal output from the optical communication line;
a second optical circulator that allows a signal, which is received from the 1×2 coupler, and a signal, which is output to the 1×2 coupler, to be transmitted and received along different paths; and
a pair of amplifiers that are disposed in opposite directions on two paths between the first optical circulator and the second optical circulator, and compensate signals, which are transmitted and received along the two paths, by amplifying the signals.

3. The WDM PON system according to claim 1, wherein the signal compensation unit comprises:
an optical circulator that allows a signal, which is output from the multiplexer/demultiplexer of the CO, and a signal, which is input to the multiplexer/demultiplexer of the CO, to be transmitted and received along different paths;
a 1×2 coupler that divides and outputs a signal to be transmitted to the optical communication line, and divides and outputs a signal received from the optical communication line; and
a pair of amplifiers that are disposed in opposite directions on two paths between the optical circulator and the 2×2 coupler, and compensate signals that are transmitted and received along the two paths by amplifying the signals.

4. The WDM PON system according to claim 1, wherein the signal compensation unit comprises:
a 1×2 coupler that divides and outputs a signal output from the multiplexer/demultiplexer of the CO, and receives a signal to be transmitted to the multiplexer/demultiplexer of the CO;
a 2×2 coupler that divides and outputs a signal to be transmitted to the optical communication line, and divides and outputs a signal received from the optical communication line; and
a pair of amplifiers that are disposed in opposite directions on two paths between the 1×2 coupler and the 2×2 coupler, and compensate signals that are transmitted and received along the two paths by amplifying the signals.

5. The WDM PON system according to claim 1, wherein the signal compensation unit comprises:
a first 1×2 coupler, which divides and outputs a signal output from the multiplexer/demultiplexer of the CO, and receives a signal to be transmitted to the multiplexer/demultiplexer of the CO;
a second 1×2 coupler that divides and outputs a signal transmitted to the optical communication line, and receives a signal output from the optical communication line;
an optical circulator that allows a signal, which is received from the second 1×2 coupler, and a signal, which is output to the second 1×2 coupler, to be transmitted and received along different paths; and
a pair of amplifiers that are disposed in opposite directions on two paths between the first 1×2 coupler and the optical circulator, and compensate signals that are transmitted and received along the two paths by amplifying the signals.

6. The WDM PON system according to claim 1, wherein the signal compensation unit comprises:
a first 1×2 coupler that divides and outputs a signal output from the multiplexer/demultiplexer of the CO, and receives a signal transmitted to the multiplexer/demultiplexer of the CO;
a pair of optical circulators that are disposed on two ends of a divided side of the first 1×2 coupler, respectively, and allows a signal, which is divided and output by the first 1×2 coupler, and a signal, which is input to the first 1×2 coupler, to be transmitted and received along different paths;
a pair of second 1×2 couplers that output respective signals to be transmitted to the optical communication line and divide and output respective signals received from the optical communication line; and
a pair of amplifier pairs each of which has a pair of amplifiers disposed in opposite directions on two paths between each of the optical circulators and each of the second 1×2 couplers, and compensate signals, which are transmitted and received along the two paths, by amplifying the signals.

7. The WDM PON system according to claim 1, wherein the signal compensation unit comprises:
a 1×2 coupler that divides and outputs a signal output from the multiplexer/demultiplexer of the CO, and receives a signal to be transmitted to the multiplexer/demultiplexer of the CO;
a pair of optical circulators that allow a signal, which is divided and output by the 1×2 coupler, and a signal, which is input to the 1×2 coupler, to be transmitted and received along different paths;
a pair of second optical circulators that allow a signal, which is transmitted to the optical communication line, and a signal, which is received from the optical communication line, to be transmitted and received along different paths; and
a pair of amplifier pairs each of which has a pair of amplifiers disposed in opposite directions on two paths between each of the first optical circulators and each of the second optical circulators, and compensate signals, which are transmitted and received along the two paths, by amplifying the signals.

8. A WDM PON system comprising:
a ring-type optical communication line;
a CO comprising a plurality of general Media Converters (MCs) having a plurality of optical transmission units that generate optical signals having different wavelengths, and optical reception units each of which forms a pair with a corresponding one of the optical transmission units, receives an optical signal having a wavelength identical to that of the corresponding one of the optical transmission units, and converts the received optical signal into an electrical signal, a multiplexer/demultiplexer that multiplexes and outputs optical signals having different wavelengths, which are received from the MCs, to the optical communication line, and demultiplexes a multiplexed optical signal, which is received through an optical communication line, and then outputs demultiplexed optical signals to the MCs, and a plurality of optical circulators that output optical signals, which are output from optical transmission units of the MCs, to the multiplexer/demultiplexer, and output the optical signals, which are demultiplexed and received by the multiplexer/demultiplexer, to optical reception units of the MCs; and
one or more RNs each comprising an optical add/drop multiplexer that drops only signals having wavelengths in a predetermined band from optical signals transmitted through the optical communication line, and then outputs the dropped signals to subscriber devices, and outputs optical signals, which are received from the subscriber devices, to the optical communication line, and a redundancy general MC that has first and second optical circulators connected to a master channel and a slave channel of the optical add/drop multiplexer, respectively, master and slave optical transceiver units configured to generate an optical signal and transmit the generated optical signal to one of the first and second optical circulators, and convert optical signals, which are transmitted through the optical circulators, into electrical signals and then output the converted optical signals to the subscriber devices, a controller configured to detect states of the master and slave optical transceiver units and a cut state of the line and activate only one of the optical transceiver units, and interface units respectively connected to the master and slave optical transceiver units and configured to perform data interfacing with the subscriber devices;
wherein the WDM PON system further comprises a signal compensation unit that compensates signals that are transmitted and received between the optical communication line and the multiplexer/demultiplexer of the CO.

9. The WDM PON system according to claim 8, wherein the signal compensation unit comprises:
a first optical circulator that allows a signal, which is output from the multiplexer/demultiplexer of the CO, and a signal, which is input to the multiplexer/demultiplexer of the CO, to be transmitted and received along different paths;
a 1×2 coupler that divides and outputs a signal to be transmitted to the optical communication line, and receives a signal output from the optical communication line;
a second optical circulator that causes a signal, which is received from the 1×2 coupler, and a signal, which is output to the 1×2 coupler, to be transmitted and received along different paths; and
a pair of amplifiers that are disposed in opposite directions on two paths between the first optical circulator and the second optical circulator, and compensate signals, which are transmitted and received along the two paths, by amplifying the signals.

10. The WDM PON system according to claim 8, wherein the signal compensation unit comprises:
an optical circulator that allows a signal, which is output from the multiplexer/demultiplexer of the CO, and a signal, which is input to the multiplexer/demultiplexer of the CO, to be transmitted and received along different paths;
a 1×2 coupler that divides and outputs a signal transmitted to the optical communication line, and divides and outputs a signal received from the optical communication line; and
a pair of amplifiers that are disposed in opposite directions on two paths between the optical circulator and the 2×2 coupler, and compensate signals, which are transmitted and received along the two paths, by amplifying the signals.

11. The WDM PON system according to claim 8, wherein the signal compensation unit comprises:
a 1×2 coupler that divides and outputs a signal output from the multiplexer/demultiplexer of the CO, and receives a signal transmitted to the multiplexer/demultiplexer of the CO;
a 2×2 coupler that divides and outputs a signal transmitted to the optical communication line, and divides and outputs a signal received from the optical communication line; and
a pair of amplifiers that are disposed in opposite directions on two paths between the 1×2 coupler and the 2×2 coupler, and compensate signals, which are transmitted and received along the two paths, by amplifying the signals.

12. The WDM PON system according to claim 8, wherein the signal compensation unit comprises:
a first 1×2 coupler that divides and outputs a signal output from the multiplexer/demultiplexer of the CO, and receives a signal transmitted to the multiplexer/demultiplexer of the CO;
a second 1×2 coupler that divides and outputs a signal transmitted to the optical communication line, and receives a signal output from the optical communication line;
an optical circulator that allows a signal, which is received from the second 1×2 coupler, and a signal, which is output to the second 1×2 coupler, to be transmitted and received along different paths; and
a pair of amplifiers that are disposed in opposite directions on two paths between the first 1×2 coupler and the optical circulator, and compensate signals, which are transmitted and received along the two paths, by amplifying the signals.

13. The WDM PON system according to claim 8, wherein the signal compensation unit comprises:
a first 1×2 coupler that divides and outputs a signal output from the multiplexer/demultiplexer of the CO, and receives a signal transmitted to the multiplexer/demultiplexer of the CO;
a pair of optical circulators that are disposed on two ends of a divided side of the first 1×2 coupler, respectively, and allow a signal, which is divided and output by the first 1×2 coupler, and a signal, which is input to the first 1×2 coupler, to be transmitted and received along different paths;
a pair of second 1×2 couplers that output respective signals transmitted to the optical communication line, and divide and output respective signals received from the optical communication line; and
a pair of amplifier pairs each of which has a pair of amplifiers disposed in opposite directions on two paths between each of the optical circulators and each of the second 1×2 couplers, and compensate signals, which are transmitted and received along the two paths, by amplifying the signals.

14. The WDM PON system according to claim 8, wherein the signal compensation unit comprises:
a 1×2 coupler that divides and outputs a signal output from the multiplexer/demultiplexer of the CO, and receives a signal transmitted to the multiplexer/demultiplexer of the CO;
a pair of optical circulators that allow a signal, which is divided and output by the 1×2 coupler, and a signal, which is input to the 1×2 coupler, to be transmitted and received along different paths;
a pair of second optical circulators that allow a signal, which is transmitted to the optical communication line, and a signal, which is received from the optical communication line, to be transmitted and received along different paths; and
a pair of amplifier pairs each of which has a pair of amplifiers disposed in opposite directions on two paths between each of the first optical circulators and each of the second optical circulators, and compensate signals, which are transmitted and received along the two paths, by amplifying the signals.

15. A multi-ring type WDM PON system, comprising:
a ring-type optical communication line;
a CO comprising a plurality of optical transmission units that generate optical signals having different wavelengths, optical reception units each of which forms a pair with a corresponding one of the optical transmission units, receives an optical signal having a wavelength identical to that of the corresponding one of the optical transmission units and converts the optical signal into an electrical signal, a multiplexer/demultiplexer that multiplexes input optical signals having different wavelengths and then outputs a multiplexed optical signal to the optical communication line, and demultiplexes and outputs multiplexed optical signals that are received through the optical communication line, and a plurality of optical circulators each of which outputs an optical signal, which is output from a designated one of the optical transmission units, to the multiplexer/demultiplexer, and outputs an optical signal, which is demultiplexed and received by the multiplexer/demultiplexer, to a designated one of the optical reception units; and
one or more RNs comprising an optical add/drop multiplexer that drops only signals having wavelengths in a predetermined band from optical signals transmitted through the optical communication line and then outputs the dropped signals to subscriber devices, and outputs optical signals, which are received from the subscriber devices, to the optical communication line, and optical circulators that output optical signals, which are dropped through the optical add/drop multiplexer, to the optical reception units of the subscriber devices, and output optical signals, which are received from the optical transmission units of the subscriber devices, to the optical add/drop multiplexer;
wherein the WDM PON system comprises:
a plurality of ring-type optical communication lines;
a plurality of signal compensation units that are connected to the ring-type optical communication lines, respectively, and compensate signals transmitted and received between the optical communication line and the multiplexer/demultiplexer of the CO; and
an optical coupler that is connected between each of the plurality of signal compensation units and the multiplexer/demultiplexer of the CO, and divides a signal output from the multiplexer/demultiplexer and then outputs divided signals to the respective signal compensation units, or outputs signals, which are respectively output from the signal compensation units, to the multiplexer/demultiplexer.

16. The WDM PON system according to claim 15, wherein the signal compensation unit comprises:
a first optical circulator that allows a signal, which is output from the multiplexer/demultiplexer of the CO, and a signal, which is input to the multiplexer/demultiplexer of the CO, to be transmitted and received along different paths;
a 1×2 coupler that divides and outputs a signal transmitted to the optical communication line, and receives a signal output from the optical communication line;
a second optical circulator that allows a signal, which is received from the 1×2 coupler, and a signal, which is output to the 1×2 coupler, to be transmitted and received along different paths; and
a pair of amplifiers that are disposed in opposite directions on two paths between the first optical circulator and the second optical circulator, and compensate signals, which are transmitted and received along the two paths, by amplifying the signals.

17. The WDM PON system according to claim 15, wherein the signal compensation unit comprises:
an optical circulator that allows a signal, which is output from the multiplexer/demultiplexer of the CO, and a signal, which is input to the multiplexer/demultiplexer of the CO, to be transmitted and received along different paths;
a 1×2 coupler that divides and outputs a signal transmitted to the optical communication line, and divides and outputs a signal received from the optical communication line; and
a pair of amplifiers that are disposed in opposite directions on two paths between the optical circulator and the 2×2 coupler, and compensate signals, which are transmitted and received along the two paths, by amplifying the signals.

18. The WDM PON system according to claim 15, wherein the signal compensation unit comprises:
a 1×2 coupler that divides and outputs a signal output from the multiplexer/demultiplexer of the CO, and receives a signal transmitted to the multiplexer/demultiplexer of the CO;
a 2×2 coupler that divides and outputs a signal transmitted to the optical communication line, and divides and outputs a signal received from the optical communication line; and
a pair of amplifiers that are disposed in opposite directions on two paths between the 1×2 coupler and the 2×2 coupler, and compensate signals, which are transmitted and received along the two paths, by amplifying the signals.

19. The WDM PON system according to claim 15, wherein the signal compensation unit comprises:
a first 1×2 coupler that divides and outputs a signal output from the multiplexer/demultiplexer of the CO, and receives a signal transmitted to the multiplexer/demultiplexer of the CO;
a second 1×2 coupler that divides and outputs a signal transmitted to the optical communication line, and receives a signal output from the optical communication line;
an optical circulator that allows a signal, which is received from the second 1×2 coupler, and a signal, which is output to the second 1×2 coupler, to be transmitted and received along different paths; and
a pair of amplifiers that are disposed in opposite directions on two paths between the first 1×2 coupler and the optical circulator, and compensate signals, which are transmitted and received along the two paths, by amplifying the signals.

20. The WDM PON system according to claim 15, wherein the signal compensation unit comprises:
a first 1×2 coupler that divides and outputs a signal output from the multiplexer/demultiplexer of the CO, and receives a signal transmitted to the multiplexer/demultiplexer of the CO;
a pair of optical circulators that are disposed on two ends of a divided side of the first 1×2 coupler, respectively, and allow a signal, which is divided and output by the first 1×2 coupler, and a signal, which is input to the first 1×2 coupler, to be transmitted and received along different paths;
a pair of second 1×2 couplers that output respective signals transmitted to the optical communication line, and divide and output respective signals received from the optical communication line, respectively; and
a pair of amplifier pairs each of which has a pair of amplifiers disposed in opposite directions on two paths between each of the optical circulators and each of the second 1×2 couplers, and compensates signals, which are transmitted and received along the two paths, respectively.

21. The WDM PON system according to claim 15, wherein the signal compensation unit comprises:
a 1×2 coupler that divides and outputs a signal output from the multiplexer/demultiplexer of the CO, and receives a signal transmitted to the multiplexer/demultiplexer of the CO;
a pair of optical circulators that allow a signal, which is divided and output by the 1×2 coupler, and a signal, which is input to the 1×2 coupler, to be transmitted and received along different paths;
a pair of second optical circulators that allow a signal, which is transmitted to the optical communication line, and a signal, which is received from the optical communication line, to be transmitted and received along different paths; and
a pair of amplifier pairs each of which has a pair of amplifiers disposed in opposite directions on two paths between each of the first optical circulators and each of the second optical circulators, and compensates signals, which are transmitted and received along the two paths, by amplifying the signals.
